(19) United States
(12) Patent Application Publication
(10) Pub. No.: US 2026/0267020 A1
(43) Pub. Date: Sep. 10, 2026

(54) SUBTERRANEAN FORMATION CHARACTERIZATION BY COUPLED ACOUSTIC AND ELECTROMAGNETIC MEASUREMENTS USING OPTICAL FIBER

(71) Applicant: Saudi Arabian Oil Company, Dhahran (SA)

(72) Inventors: Timur Zharnikov, Moscow (RU); Daniele Colombo, Dhahran (SA); Maksim Bazulin, Moscow (RU)

(21) Appl. No.: 19/069,930

(22) Filed: Mar. 4, 2025

(51) Int. Cl. G01V 1/22; E21B 47/135; E21B 47/14; E21B 49/00; G01V 1/30

(52) U.S. Cl. CPC G01V 1/226; E21B 47/135; E21B 47/14; E21B 49/008; G01V 1/302

(57) ABSTRACT

Systems and methods include characterization and monitoring of subterranean formations. For characterizing and monitoring the subterranean formations, a wave source generates a wave propagating in a subterranean formation. A signal generated in response to an electrokinetic effect is detected by an optical fiber. The data acquisition is synchronized with the activation of the wave source. The received data is processed to determine characteristics of the subterranean formation including formation properties such as: porosity, permeability, saturations, fluid flow, and flow type. A mapping of the characteristics of the subterranean formation is generated. A field operation within the subterranean formation is triggered based on the mapping of the characteristics of the subterranean formation.

### TECHNICAL FIELD

This disclosure relates to subterranean formation real time monitoring systems and, more specifically, to formation characterization and monitoring by coupled acoustic and electromagnetic measurements using optical fiber.

### BACKGROUND

Exploration and production of hydrocarbons can include investigations of regions of an earth formation penetrated by a wellbore. Electrical earth wellbore logging is a commonly used technique for formation characterization. Some electrical logging system can include measurement electrodes (current sources or sinks) in conjunction with a return electrode, which might be a diffuse electrode like the logging tool's body or mandrel. The measurement current flows in a circuit from the current source to the measurement electrodes, such that measuring the current flow and interpreting the data can be affected by the complex properties of the earth formation. Other electrical logging system can include inductive measuring tools that induce a current flow within the earth formation. The magnitude of the induced current is detected using either the same antenna or a separate receiver antenna, which is influenced by the subterranean formation's electrical conductivity, magnetic permeability, dielectric permittivity, pore volume, porosity, and water saturation.

### SUMMARY

Implementations of the present disclosure are directed to subterranean formation real time monitoring systems. More particularly, implementations of the present disclosure are directed to formation characterization and monitoring by coupled acoustic and electromagnetic measurements using optical fiber.

In some implementations, a method includes: generating, by activating a wave source, a wave propagating in a subterranean formation, receiving, from an optical fiber, data transmitted through the optical fiber in response to an electrokinetic effect generated in the subterranean formation in response to the wave propagating through the subterranean formation, receiving, from a sensor, additional data synchronized with the data transmitted through the optical fiber, determining, by processing the data transmitted through the optical fiber and the additional data, characteristics of the subterranean formation, the processing including a temporal alignment of the data transmitted through the optical fiber and the additional data, generating a mapping of the characteristics of the subterranean formation, the mapping defining a variation of the characteristics throughout the subterranean formation, and triggering a field operation within the subterranean formation based on the mapping of the characteristics of the subterranean formation.

The foregoing and other implementations can each optionally include one or more of the following features, alone or in combination. In particular, implementations can include all the following features:

In a first aspect, combinable with any of the previous aspects, wherein the wave includes an acoustic wave or an electromagnetic field. In another aspect, combinable with any of the previous aspects, the optical fiber is within or proximal to a wellbore formed within the subterranean formation. In another aspect, combinable with any of the previous aspects, the wave source is within or proximal to the wellbore formed within the subterranean formation. In another aspect, combinable with any of the previous aspects, the optical fiber covers a plurality of azimuths. In another aspect, combinable with any of the previous aspects, the optical fiber includes localized sensors including any of Bragg gratings, optic hydrophones, coiled sections, electromagnetic sensitive coated sensors, and piezo elements. In another aspect, combinable with any of the previous aspects, determining, by processing the data transmitted through the optical fiber, characteristics of the subterranean formation includes: removing background noise using adaptive noise cancellation algorithms, preprocessing the data to separate acoustic data from electromagnetic data, determining coupling factors between the acoustic data and the electromagnetic data, and determining the characteristics of the subterranean formation based on the coupling factors. In another aspect, combinable with any of the previous aspects, the field operation includes fluid injection, hydraulic fracturing, or well drilling.

Other implementations of the aspect include corresponding systems, apparatus, and computer programs, configured to perform the actions of the methods, encoded on computer storage devices.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

Implementations described in the present disclosure, provide multiple technical advantages. For example, the subterranean formation characterization and monitoring systems described in the present disclosure enable continuous, real-time monitoring of subterranean formation characteristics, facilitating long-time accumulation of signals. The described formation characterization and monitoring systems advantageously integrate acoustic and electromagnetic measurements with an increased measurement aperture. An advantage of the increased measurement aperture is the enhancement of the resolution of the data, providing finer details about the subterranean formation structure and heterogeneities. Aa another advantage, the described technology integrates both acoustic and electromagnetic measurements that can be correlated to accurately characterize subterranean formations at multiple points in time. The integration of acoustic and electromagnetic measurements advantageously provides a detailed understanding of the subterranean formation's properties, such as permeability, porosity, and fractures, by capturing different types of data. Another advantage of the described technology is that the combination of different measurement techniques improves the ability to detect and analyze anomalies within the subterranean formation, such as fractures or fluid boundaries. Another advantage of the described technology is that it provides key recommended actions for improving field (well and hydrocarbon reservoir) safety to ensure optimization and continuity of field operations. Furthermore, the described subterranean formation characterization approach integrates machine learning models that are trained in in controlled environments to expand the characterization of the subterranean formation characterization from limited data sets.

The details of one or more implementations of the subject matter of the specification are set forth in the accompanying drawings and the description below. Other features, aspects, and advantages of the subject matter can become apparent from the description, the drawings, and the claims.

### DESCRIPTION OF DRAWINGS

The accompanying drawings, which are incorporated in and constitute a part of this specification, show particular aspects of the subject matter disclosed herein and, together with the description, help explain some of the principles associated with the disclosed implementations. In the drawings,

FIG. 1A shows an example fiber optic monitoring system that can be used to execute implementations of the present disclosure;

FIG. 1B shows another example fiber optic monitoring system that can be used to execute implementations of the present disclosure;

FIG. 1C shows another example fiber optic monitoring system that can be used to execute implementations of the present disclosure;

FIG. 1D shows another example fiber optic monitoring system that can be used to execute implementations of the present disclosure;

FIG. 1E shows another example fiber optic monitoring system that can be used to execute implementations of the present disclosure;

FIG. 1F shows another example fiber optic monitoring system that can be used to execute implementations of the present disclosure;

FIG. 1G shows another example fiber optic monitoring system that can be used to execute implementations of the present disclosure;

FIG. 1H shows another example fiber optic monitoring system that can be used to execute implementations of the present disclosure;

FIG. 1I shows another example fiber optic monitoring system that can be used to execute implementations of the present disclosure;

FIG. 1J shows another example fiber optic monitoring system that can be used to execute implementations of the present disclosure;

FIG. 1K shows another example fiber optic monitoring system that can be used to execute implementations of the present disclosure;

FIG. 1L shows another example fiber optic monitoring system that can be used to execute implementations of the present disclosure;

FIG. 1M shows another example fiber optic monitoring system that can be used to execute implementations of the present disclosure;

FIG. 2 is a block diagram of an example system that can be used to execute implementations of the present disclosure;

FIG. 3A depicts a flowchart illustrating an example process for subterranean formation real time monitoring, in accordance with some example implementations;

FIG. 3B depicts a flowchart illustrating an example process for subterranean formation real time monitoring, in accordance with some example implementations;

FIG. 4 depicts a block diagram illustrating a computing system, in accordance with some example implementations; and

FIG. 5 illustrates hydrocarbon production operations, in accordance with some example implementations.

When practical, like labels are used to refer to same or similar items in the drawings.

### DETAILED DESCRIPTION

Implementations of the present disclosure are directed to subterranean formation real time monitoring systems. More particularly, implementations of the present disclosure are directed to characterization and monitoring of subterranean formations by coupled acoustic and electromagnetic measurements using optical fiber. A subterranean formation refers to a layer or stratum of rock or sediment located beneath the Earth's surface. The subterranean formations can vary widely in composition, including types such as sandstone, limestone, shale, and more. For characterizing and monitoring the subterranean formations, a wave source generates a wave propagating in a subterranean formation. A signal generated in response to an electrokinetic effect is detected by an optical fiber. The data acquisition is synchronized with the activation of the wave source. The received data is processed to determine characteristics of the subterranean formation including formation properties such as: porosity, permeability, saturations, fluid flow, and flow type. A mapping of the characteristics of the subterranean formation is generated. A field operation within the subterranean formation is triggered based on the mapping of the characteristics of the subterranean formation.

Subterranean formations are significant in various fields, including geology, petroleum engineering, and environmental science, as they contain valuable resources including groundwater, oil, natural gas, and minerals. Some traditional subterranean formation characterization techniques provide spatially limited information and/or temporally limited information that impede efficiency of subterranean formation monitoring. Addressing the challenges of traditional subterranean formation characterization, the subterranean formation characterization and monitoring systems described in the present disclosure enable continuous, real-time monitoring of subterranean formation characteristics, facilitating long-time accumulation of signals. The described formation characterization and monitoring systems integrate optical fiber based acoustic and electromagnetic measurements with an increased measurement aperture. An advantage of the increased measurement aperture is the enhancement of the resolution of the data, providing finer details about the subterranean formation structure and heterogeneities.

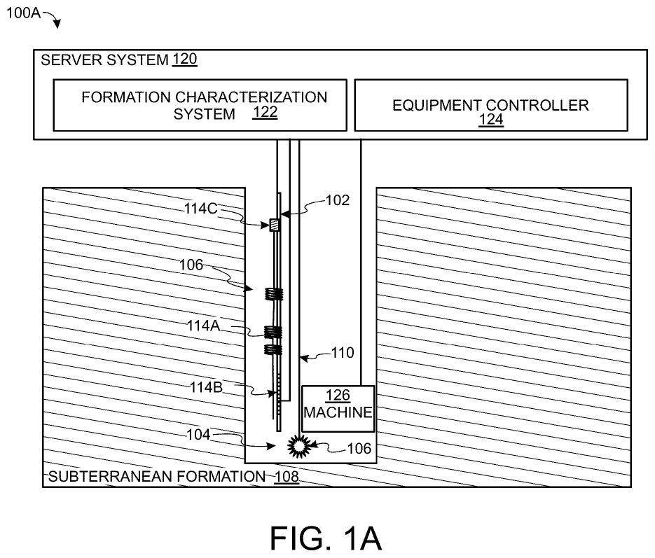

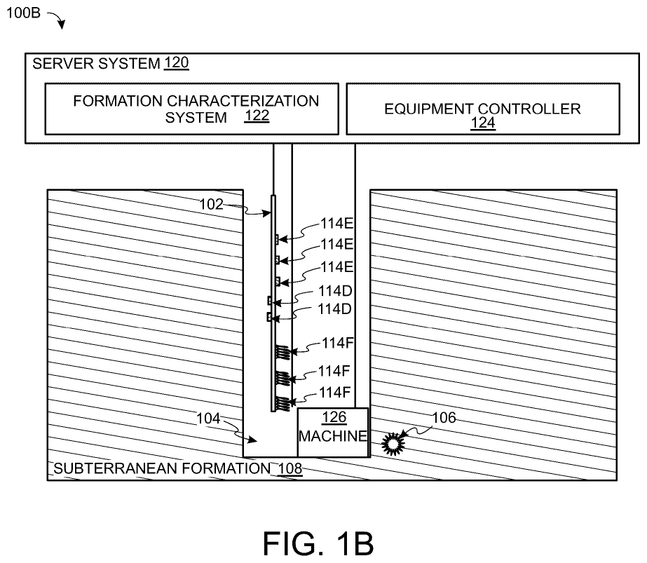

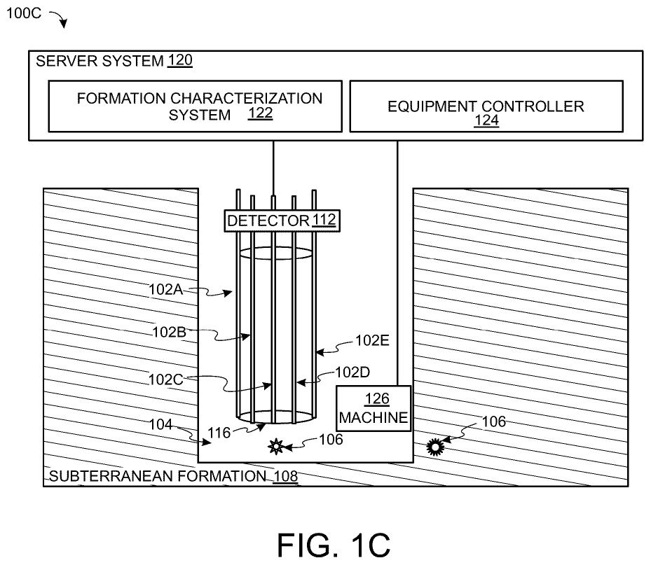

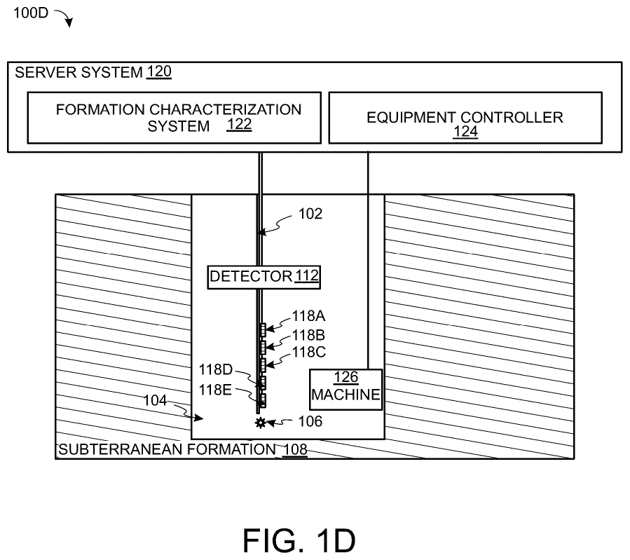

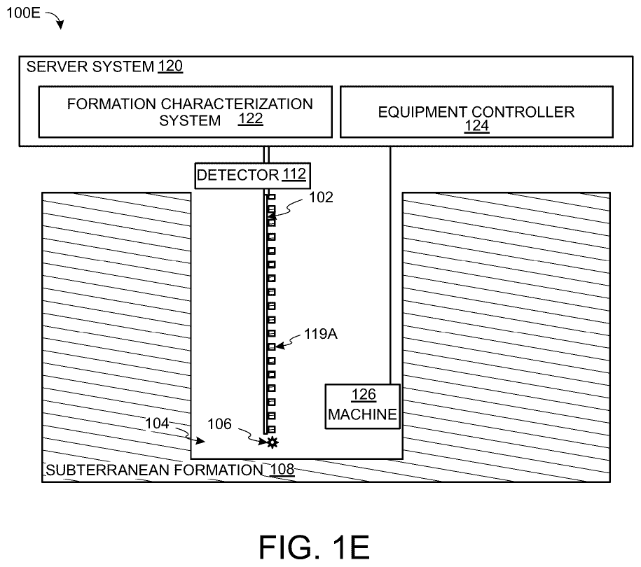

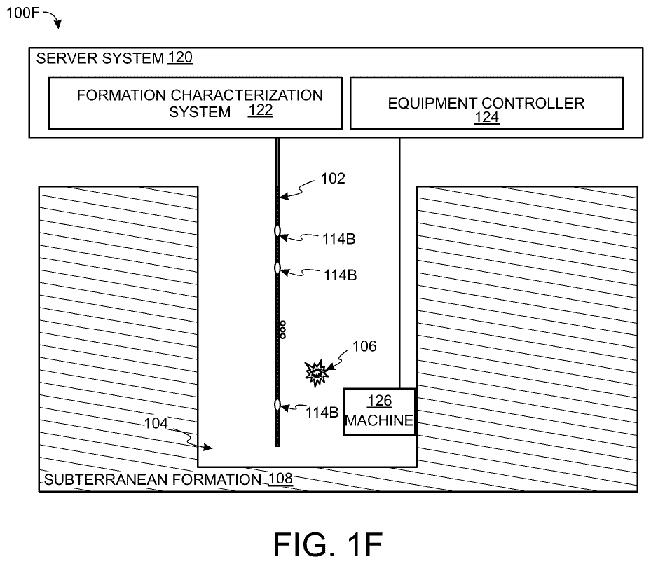

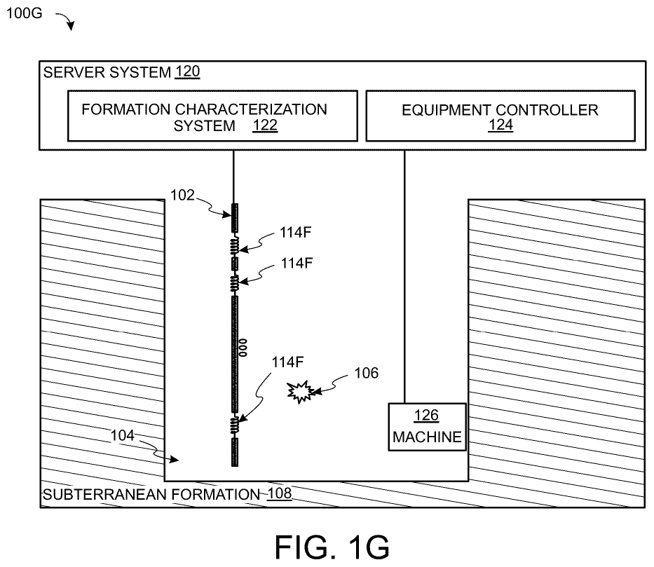

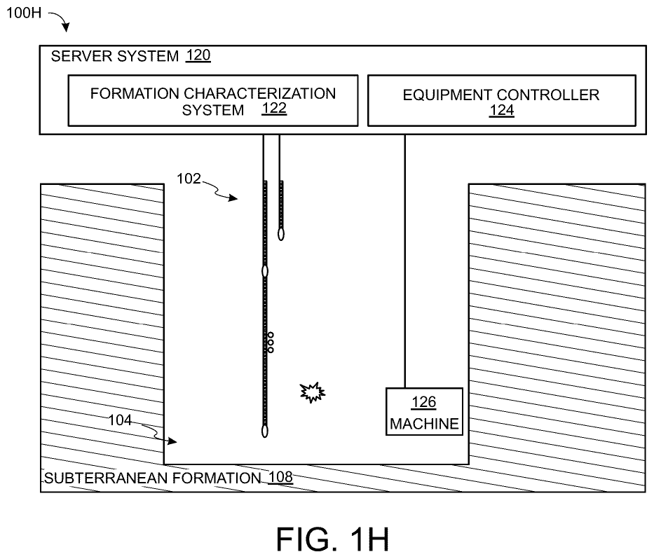

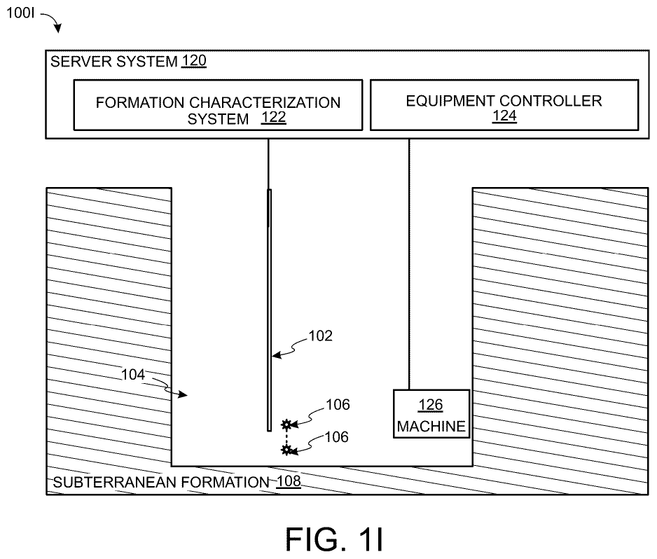

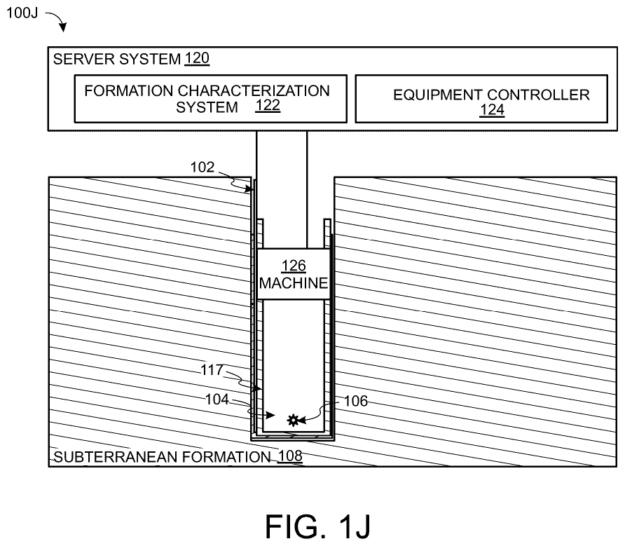

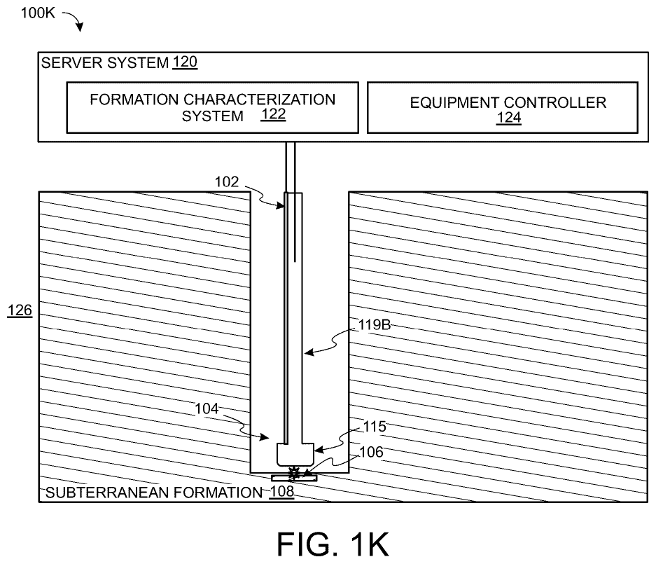

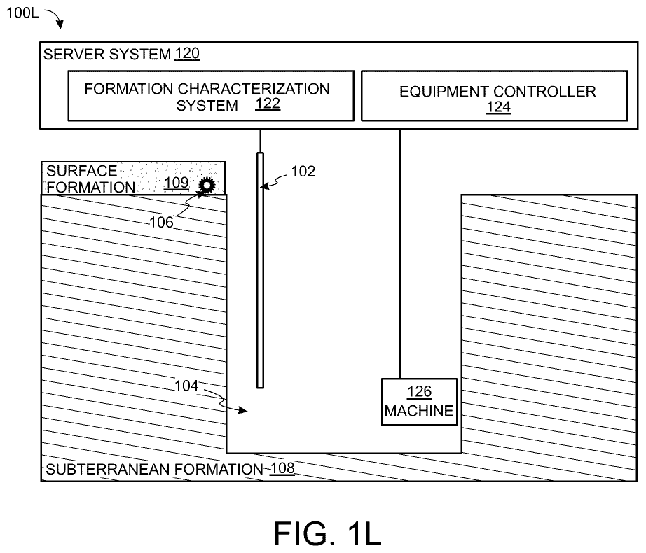

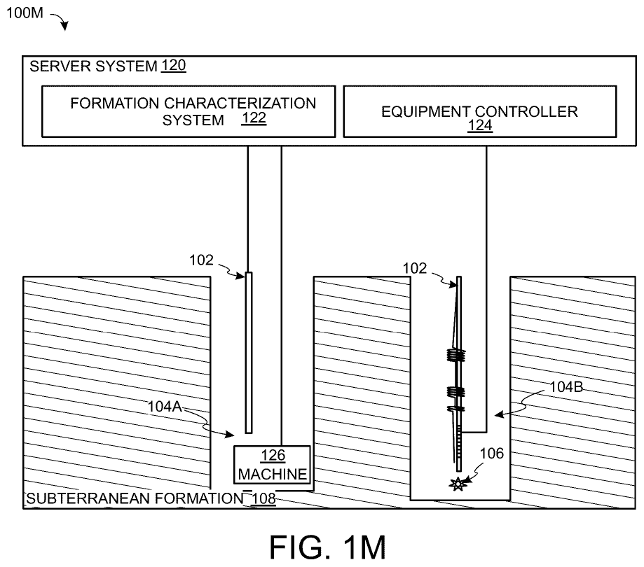

Another advantage of the described technology is that it integrates both acoustic and electromagnetic measurements, such that the system can cross-verify data, leading to more accurate and reliable formation characterization. The integration advantageously provides a detailed understanding of the subterranean formation's properties, such as permeability, porosity, and fractures, by capturing different types of data. Another advantage of the described technology is that the combination of different measurement techniques improves the ability to detect and analyze anomalies within the subterranean formation, such as fractures or fluid boundaries. Another advantage of the described technology is that it provides key recommended actions for improving resource management, environmental impact assessment, and subsurface exploration. Furthermore, the described subterranean formation characterization approach integrates machine learning models that are trained in in controlled environments to expand the characterization of the subterranean formation characterization from limited data sets. Fine tuning of machine learning models can maximize the accuracy of subterranean formation characterization. Other advantages of the subterranean formation real time monitoring techniques are described with reference to FIGS. 1A-1M and 2-5.

FIG. 1A shows an example fiber optic monitoring system 100A that can be used to execute implementations of the present disclosure. FIG. 1B shows another example fiber optic monitoring system 100B that can be used to execute implementations of the present disclosure. FIG. 1C shows another example fiber optic monitoring system 100C that can be used to execute implementations of the present disclosure. FIG. 1D shows another example fiber optic monitoring system 100D that can be used to execute implementations of the present disclosure. FIG. 1E shows another example fiber optic monitoring system 100E that can be used to execute implementations of the present disclosure. FIG. 1F shows another example fiber optic monitoring system 100F that can be used to execute implementations of the present disclosure. FIG. 1G shows another example fiber optic monitoring system 100G that can be used to execute implementations of the present disclosure. FIG. 1H shows another example fiber optic monitoring system 100H that can be used to execute implementations of the present disclosure. FIG. 1I shows another example fiber optic monitoring system 100I that can be used to execute implementations of the present disclosure. FIG. 1J shows another example fiber optic monitoring system 100J that can be used to execute implementations of the present disclosure. FIG. 1K shows another example fiber optic monitoring system 100K that can be used to execute implementations of the present disclosure. FIG. 1L shows another example fiber optic monitoring system 100L that can be used to execute implementations of the present disclosure. FIG. 1M shows another example fiber optic monitoring system 100M that can be used to execute implementations of the present disclosure.

The example fiber optic monitoring system 100A-100M includes an optical fiber 102 positioned relative to a wellbore 104. The optical fiber 102 can be arranged in different configurations relative to the wellbore 104. For example, the optical fiber 102 can be cemented behind casing (as shown in FIG. 1J), lowered into the wellbore separately (as shown in FIG. 1I), lowered into the wellbore 104 as a part of the wireline cable 119A (as shown in FIG. 1E), conveyed on drill string 119B (as shown in FIG. 1K), or a coiled tubing. The optical fiber 102 can be permanently installed relative to the wellbore 104.

The optical fiber 102 can act as a sensor or can be attached to a sensor, to acquire acoustic measurements in 1 Hz-250 kHz frequency range and electromagnetic measurements in the same frequency range (1 Hz-250 kHz), optionally in addition to seismic data including nature induced seismic signals and drilling induced seismic signals having frequencies from several Hz to several hundreds of Hz. In some implementations, the acoustic and/or electromagnetic field can be generated by different sources, including nature induced phenomena, micro-seismicity, fluid flow through portions of the subterranean formation, fractures, and drill bit operations.

The example fiber optic monitoring system 100A-100M includes a signal source 106. The signal source 106 can include a single source (as shown in FIG. 1A-1H and 1J-1M) or an array of sources (as shown in FIG. 1I). The signal source 106 can generate acoustic and elastic waves (including the compressional and the shear waves) within a wellbore 104 (as shown in FIG. 1A), outside the wellbore 104 (as shown in FIG. 1B), or both within the wellbore 104 and outside the wellbore 104 (as shown in FIG. 1C), in the subterranean formation 108. The signal source 106 can generate an electromagnetic field within a wellbore 104 and/or outside the wellbore 104, in the subterranean formation 108.

The signal source 106 can be within the subterranean formation 108 (as shown in FIGS. 1A-1K) or in a surface formation (as shown in FIG. 1L). The signal source 106 can be placed into the same wellbore 104 as the optical fiber 102 or a neighbor wellbore for cross-well imaging (as shown in FIG. 1M). The signal source 106 can be lowered on a cable 110, autonomous (e.g., driven by a ball dropped in the well travelling to the bottom using weight and returning to the surface through buoyancy). For example, the signal source 106 including an acoustic source, can be lowered into the wellbore 104 using a monopole such that the sound waves can propagate through the subterranean formation 108. The monopole configuration facilitates focusing the acoustic energy, making it effective for various measurements and analyses, such as determining formation properties and detecting fractures or other anomalies.

Due to the electrokinetic effect, the field generated by the signal source 106 is converted within the subterranean formation 108 into a secondary field. For example, the acoustic/elastic field generates an electromagnetic field as a secondary field and an electromagnetic field generates an acoustic/elastic field as a secondary field. Both the original field (excited either by the source(s) or naturally) and the generated other field are further detected. The signal source 106 can be further used for the purpose of determining the positions/synchronizing a detector 112. The detection of the field can be done in a distributed manner, wherein fiber optic cables 102 are used to detect and measure seismic waves along their entire length, providing continuous and distributed sensing capabilities. The distributed detection approach facilitates high-resolution data collection over long distances (covering a significant portion, greater than half, of the wellbore depth), enabling effective monitoring and analysis of subsurface formations. Distributed sensing is particularly useful for identifying changes in the formation, such as fractures or fluid movements, and can significantly enhance the accuracy and detail of subsurface characterization.

The detector 112 can be used to measure subterranean data including acoustic and electromagnetic data propagated through the subterranean formation 108 and indicative of petrophysical properties of subterranean formations. The subterranean data can include additional information such as seismic data, pressure data, flow data, and/or image logs that can be used to build a natural fracture network.

The detector 112 can include static and/or mobile sensors 114, 118 recording data at multiple locations along the optical fiber 102 and, optionally, multiple locations within the subterranean formation 108 (e.g., within different wellbores 104A, 104B) located at particular points of interest within a geographical region of the subterranean formation 108. The detector 112 can record data according to a set frequency and/or a schedule and can transmit the collected data in real time (within less than a second after data collection) to the server system 120 to be processed by the formation characterization system 122. The detector 112 can be wired or wirelessly connected to the server system 120.

One or more sensors 114, 118 of the detector 112 can be coupled to (e.g., integrated in) the optical fiber 102 or one or more industrial systems (e.g., the wellhead, the machine, and/or the machine 126) or can be separated from the industrial systems. For example, one or more sensors 114, 118 of the detector 112 can be installed near the wellhead 115 to detect surface pressure in the proximity of the wellhead 115. One or more sensors 114, 118 of the detector 112 can be connected to the wellhead 115 (e.g., near a valve or a flowline) to monitor a property of a fluid flowing though the corresponding portion of the wellhead 115 (e.g., from the wellhead 115 through a flowline or the machine 126).

In some implementations, the detector 112 can include or can be attached to an array of distributed localized sensors 114A-114F. In the case of using optical fiber 102 to detect an acoustic field, the examples of the localized sensors 114A-114F include coiled fiber receivers 114A, fiber Bragg gratings 114B, fiber optic hydrophones 114C (as shown in FIG. 1A). Another example detector 112 using optical fiber 102 to detect electromagnetic field, can include multiple sensors that include resistive elements 114D, piezoceramic elements 114E, and electromagnetic field sensitive element 114F coupled to the optical fiber 102 (as shown in FIG. 1B). The resistive elements 114D can be heated by the electromagnetic signal, coupled to the optical fiber 102, which can measure the temperature (as shown in FIG. 1B). The piezoelectric element 114E can be coupled to the optical fiber 102 to measure a response to the electromagnetic field. The electromagnetic field sensitive element 114F can include an atomic magnetometer, coil, coupled to the fiber. The sensors 114A-114F can include electromagnetic field sensitive elements, for example, electromagnetic sensitive/flux enhancing fluid, coupled to the fiber, which measure the response to the electromagnetic field. The electromagnetic field sensitive element can include a coil coupled with an electrooptical transducer, coupled to the optical fiber 102, which measures the response to the electromagnetic field. The electromagnetic field sensitive element can include a magnetostrictive element, coupled to the fiber, which measures the response to the electromagnetic field. The distributed electromagnetic sensitive cable can be wrapped in conductive coating that can be adjusted to modify resolution and sensitivity of the sensor.

The detector 112 can be configured to provide azimuthal information characterizing the wavefield. For example, by placing multiple optical fibers 102A-102E at different azimuths (sides) within the wellbore 104. In some implementations, the optical fibers 102A-102E can be fixed at different azimuths within the wellbore 104, by winding the cable around the casing 117 (as shown in FIG. 1C). As shown in FIG. 1D, the detector 112 can include additional sensors (e.g., hydrophones 118A, electromagnetic sensors 118B, fiber optic strain sensors 118C, optical fiber interferometers 118D, PIN diodes or avalanche diodes 118E). The additional sensors 118A-118E can perform calibration, the depth tie, the source and/or determining the position(s) of the optical fiber 102, synchronizing the detector(s) 112, and the reference measurement. Azimuthal resolution of the measurement can be adjusted, by using an azimuthally sensitive receiver system. In some implementations, several (e.g., 4-12) fibers placed at different azimuths in the wellbore 104 (as shown in FIG. 1C) or the cable is wound (e.g., helically) in the wellbore 104. The placement of optical fibers 102A-102E at different azimuths in the wellbore 104 facilitates identification of azimuthal sensitivity of the receiver system by determining the difference of the signal arrival times between the optical fibers 102A-102E.

The detector 112 configured for distributed vibration measurement can achieve the resolution of 1-2 m (e.g., optical time domain reflectometry). The acoustic pressure in the wellbore 104 is in the order of 0.1-10 kPa. The sensors 114A-114F can have a resolution that enables detection of acoustic signals in the order of 0.1-10 kPa, at a frequency range of 5-20 kHz, which makes electrokinetic measurement possible. In some implementations, the sensors 114A-114F (e.g., receiver array) can be formed by attaching a number of localized sensors on the optical fiber 102, in any configuration including fiber Bragg grating (FBG), pressure sensors (as shown in FIGS. 1A, 1F), coiled sections of optical fiber (as shown in FIGS. 1A, 1G), and fiber optic pressure sensors (as shown in FIGS. 1A, 1H). In some implementations, the detector 112 can be further enhanced by adding hydrophones 114C and/or electromagnetic sensors 114F for synchronizing the source and the optical fiber receivers, for calibrating optical fiber receiver, and for facilitating a determination of the depth of optical fiber data reception.

The example fiber optic monitoring system 100A-100M can include a server system 120 that includes a formation characterization system 122 and an equipment controller 124. The formation characterization system 122 can receive and process acoustic and electromagnetic signals to characterize the subterranean formation 108. The equipment controller 124 can activate the signal source 106, the data acquisition performed by is the detector 112 and one or more field operations, such as operations performed by a machine 126. The machine 126 can include an industrial equipment configure to perform field operations. For example, the machine can include a drill bit and the equipment controller 124 can control a drill bit angle and a drilling frequency.

There can be any number of optical fibers 102A-102E per wellbore 104 in the example fiber optic monitoring system 100A-100M. Additionally, the example fiber optic monitoring system 100A-100M can include any combination of sensors 114, 118 within or in addition to the detector 112 that are capable of receiving acoustic and electromagnetic signals or any other type of signals characterizing those subterranean formation 108. Moreover, while the example fiber optic monitoring system 100A-100M are described in terms of a single or two wellbores 104, the disclosure contemplates that many (more than two) wellbores 104 can be formed within the subterranean formation 108 including any combination of the described configurations.

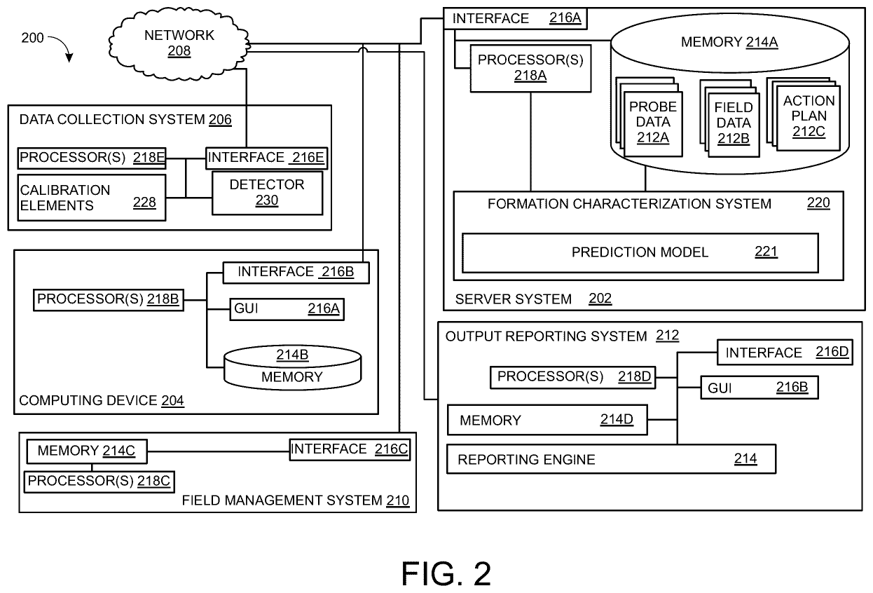

FIG. 2 is a block diagram illustrating an example system 200 for subterranean formation characterization. Specifically, the illustrated example system 200 includes or is communicably coupled with a server system 202 (e.g., server system 120 described with reference to FIGS. 1A-1M), a computing device 204, a data collection system 206 (e.g., fiber optic monitoring system 100A-100M described with reference to FIGS. 1A-1M), a network 208, an equipment controller system 210 (e.g., equipment controller 124 described with reference to FIGS. 1A-1M), and an output reporting system 212. Although shown separately, in some implementations, functionality of two or more systems or components of the example system 200 can be provided by a single system or server. In some implementations, the functionality of one illustrated system, server, or component can be provided by multiple systems, servers, or components, respectively.

In the example of FIG. 2, the server system 202 is intended to represent various forms of servers including, but not limited to a web server, an application server, a proxy server, a network server, and/or a server pool. In general, the server system 202 manages subterranean formation real time monitoring for management of field operations using any number of components of the example system 200 including computing devices 204 (e.g., over the network 208). In accordance with implementations of the present disclosure, and as noted above, the server system 202 can host a solution environment that can be a cloud environment providing software applications, systems, and services that can be consumed by customers as a service. In some instances, the server system 202 can support configuring of various tenants of different types, as well as services of different types that are integrated in customer integration scenarios and support execution of defined processes.

The server system 202 includes a memory 214A, an interface 216A, a processor 218A, and a formation characterization system 220. The memory 214A can store data (e.g., inputs and outputs of the formation characterization system 220), such as probe data 222A, field (subterranean formation) data 222B, and action plans 222C. The probe data 222A can be received from the data collection system 206. The probe data 222A can include live monitoring data, such as acoustic and electromagnetic data that can be analyzed, by the formation characterization system 220 including the prediction model 221. The field data 222B can include a characterization of the subterranean formation including a permeability and a fracture of the subterranean formation, which can be determined, by the formation characterization system 220 using the prediction model 221. The formation characterization system 220 can process data, obtained from the memory 214A, using the prediction model 221 (e.g., machine learning models) to analyze subterranean formation in real time for generating output signals for the equipment controller system 210 according to the action plans 222C.

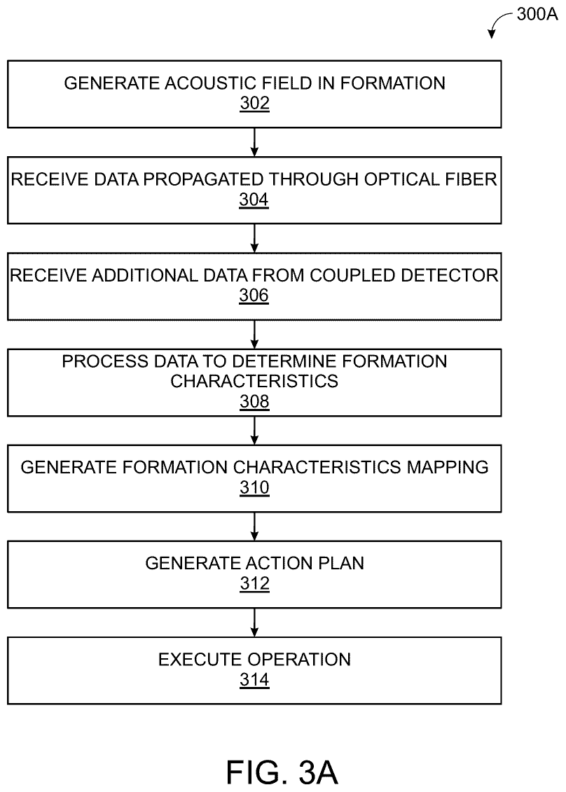

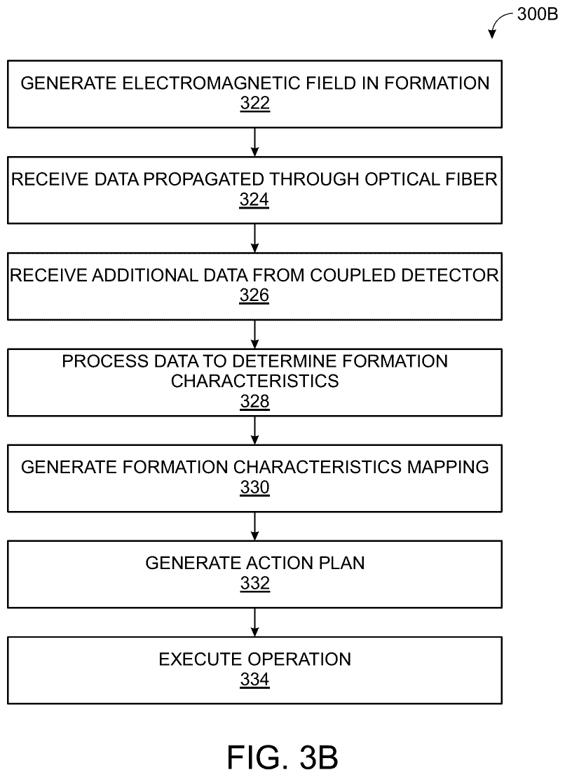

The prediction model 221 can be trained to analyze subterranean formation in real time (as described with reference to FIGS. 3A and 3B). The prediction model 221 can include gradient boosting that builds multiple decision trees sequentially, where each tree corrects the errors of the previous one. The prediction model 221 can include a random forest model that constructs multiple decision trees and averages the predictions, handling a large number of input variables received from multiple sensors of the detector 230. The prediction model 221 can include a support vector regression model that uses support vector machines to perform regression, finding the best fit line within a certain margin of tolerance that is trained for high-dimensional data, such as data received from arrays of sensors of the detector 230. The prediction model 221 can include a neural network model, which can capture intricate patterns in the data through multiple layers of neurons, configured to process large acoustic and electromagnetic datasets with complex relationships. The prediction model 221 can include a linear regression model that assumes a linear relationship between the input probe data and formation characterization.

The formation characterization system 220 can use the field data 212B (including formation characterization) to monitor and adjust in real time fluid injection, to monitor and adjust in real time hydraulic fracturing and to conduct the survey on a field (new, or brown field) for new or additional well placements and geometries to further maximize the hydrocarbon recovery rate from a respective reservoir. For example, based on the well placement and geometry of the well in the drilling environment of the subterranean formation, the formation characterization system 220 can determine that one or more wells with particular geometries and placed at particular locations can maximize the existing hydrocarbon injection and re-production rate. In some implementations, an alert generation defined by the action plans 222C can also point to an internal security regulation set within the example system 200 (e.g., regulations adjusted to reflect the vulnerabilities of the equipment controller system 210). The action plans 222C in the memory 214A can include action plan documents defining risk prevention mechanisms including operations that can be performed by the components the example system 200 to annihilate or prevent unsafe operations.

The computing device 204, the equipment controller system 210, and the output reporting system 212 can each be any computing device operable to connect to or communicate in the network(s) 208 using a wireline or wireless connection. In general, each of the computing device 204, the equipment controller system 210, and the output reporting system 212 includes an electronic computer device operable to receive, transmit, process, and store any appropriate data associated with the example system 200 of FIG. 2. Each of the computing device 204, the equipment controller system 210, and the output reporting system 212 is generally intended to encompass any client computing device such as a laptop/notebook computer, wireless data port, smart phone, personal data assistant (PDA), tablet computing device, one or more processors within these devices, or any other suitable processing device. The computing device 204, the equipment controller system 210, and the output reporting system 212, respectively include interface(s) 216B, 216C, 216D, processor(s) 218B, 218C, 218D, and memories 214B, 214C, 214D.

The computing device 204 and the output reporting system 212, respectively include graphical user interface(s) (GUIs) 226A and 226B. For example, the GUIs 226A, 226B include an input device, such as a keypad, touch screen, or other device that can accept user information, and an output device that conveys information associated with the operation of the server system 202, or the client device itself, including subterranean formation real time monitoring data (reports), and/or field operations, respectively. The GUIs 226A, 226B each interface with at least a portion of the example system 200 for any suitable purpose, including generating a visual representation of the data collected by the data collection system 206, data generated by the server system 202, or data stored by the server system 202, such as probe data 222A, field data 222B, and action plans 222C, respectively. In particular, the GUIs 226A, 226B can each be used to view and adjust various subterranean formation management operations. Generally, the GUIs 226A, 226B each provide the user with an efficient and user-friendly presentation of subterranean formation real time monitoring provided by or communicated within the example system 200. The GUIs 226A, 226B can each include multiple customizable frames or views having interactive fields, pull-down lists, and buttons operated by the user. The GUIs 226A, 226B can each be any suitable graphical user interface, such as a combination of a generic web browser, intelligent engine, and command line interface (CLI) that processes information and efficiently presents the results to the user visually.

The output reporting system 212 can include a reporting engine 224, the GUI 226B (dashboard), a user module, and administrator modules. The reporting engine 224 utilizes the analytics data provided by the formation characterization system 220 to produce alerts to be displayed by the GUI 226B. The GUI 226B displays information related to the subterranean formation real time monitoring, as described with reference to FIG. 2. The GUI 226B display can enable wellbore management by supporting modification of field operations.

The data collection system 206 can include calibration elements 228 and a detector 230 (e.g., detector 112 described with reference to FIGS. 1A-1M). The calibration elements 228 enable calibration of the detector 230 and directs collected data to the server system 202 for storage, further analysis and correlations. The detector 230 can collect surface data and subterranean data within a field including one or more wells (including wellbores) and one or more hydrocarbon reservoirs. The detector 230 can be coupled to or integrated in different types of components of the wells, to continuously monitor subterranean formation and secure the safety of the field operations.

In some implementations, the network 208 can include a large computer network, such as a local area network, a wide area network, the Internet, a cellular network, a telephone network or an appropriate combination thereof connecting any number of communication devices, mobile computing devices, fixed computing devices and server systems. Data exchanged over the network 208, is transferred using any number of network layer protocols, such as internet protocol, multiprotocol label switching, asynchronous transfer mode, Frame Relay, etc. Furthermore, in implementations where the network 208 represents a combination of multiple sub-networks, different network layer protocols are used at each of the underlying sub-networks. In some implementations, the network 208 represents one or more interconnected internetworks, such as the public Internet.

Each processor 218A, 218B, 218C, 218D, 218E included in different components of the example system 200 can include a central processing unit (CPU), an application specific integrated circuit (ASIC), a field-programmable gate array (FPGA), or another suitable component. Generally, each processor 218A, 218B, 218C, 218D, 218E executes instructions and manipulates data to perform subterranean formation real time monitoring within fields. For example, each processor 218A, 218B, 218C, 218D, 218E executes a functionality required to monitor subterranean formation in real time within fields, to plan well configurations, to execute well operations and to maintain safety of field operations.

Interfaces 216A, 216B, 216C, 216D, 216E are used by different components of the example system 200 for communicating with other component systems in a distributed environment—including within the example system 200—connected to the network 208. Generally, the interfaces 216A, 216B, 216C, 216D, 216E each include logic encoded in software and/or hardware in a suitable combination and operable to communicate with the network 208. More specifically, the interfaces 216A, 216B, 216C, 216D, 216E can each include software supporting one or more communication protocols associated with communications such that the network 208 or interface's hardware is operable to communicate physical signals within and outside of the illustrated system 200.

The memory 2114A, 214B, 214C, 214D can include any type of memory or database module and can take the form of volatile and/or non-volatile memory including, without limitation, magnetic media, optical media, random access memory (RAM), read-only memory (ROM), removable media, or any other suitable local or remote memory component. The memory 2114A, 214B, 214C, 214D can store various objects or data, including caches, classes, frameworks, applications, backup data, business objects, jobs, web pages, web page templates, database tables, database queries, repositories storing safety data and/or dynamic information, and any other appropriate information including any parameters, variables, algorithms, instructions, rules, constraints, or references thereto associated with the purposes of the server system 202, the computing device 204, the data collection system 206, the equipment controller system 210, and the output reporting system 212, respectively.

There can be any number of computing devices 204 and data collection systems 206 associated with, or external to, the example system 200. Additionally, there can also be one or more additional client devices external to the illustrated portion of system 200 that are capable of interacting with the example system 200 via the network(s) 208. Further, the term “client,” “client device,” and “user” can be used interchangeably as appropriate without departing from the scope of the disclosure. Moreover, while client device can be described in terms of being used by a single user, the disclosure contemplates that many users can use one computer, or that one user can use multiple computers. As used in the present disclosure, the term “computer” is intended to encompass any suitable processing device. For example, although FIG. 2 illustrates a single server system 202, a single computing device 204, a single data collection system 206, a single equipment controller system 210, the example system 200 can be implemented using a single, stand-alone computing device, two or more server systems 202, or multiple client devices. The server system 202, the computing device 204 and the output reporting system 212 can include any computer or processing device. According to one implementation, the server system 202 can also include or be communicably coupled with an e-mail server, a Web server, a caching server, a streaming data server, and/or another suitable server.

FIG. 3A depicts a flowchart illustrating an example process 300A for subterranean formation real time monitoring, in accordance with some example implementations. Referring to FIGS. 1A and 1B, the process 300A can be performed by any components of the example system 100. The example process 300A can be executed using, e.g., any component of the example system 100A-100M described with reference to FIGS. 1A-1M or example system 200, 400, 500 described with reference to FIGS. 2. 4, and 5. Operations of the process 300A are described below for illustration purposes only. Operations of the process 300A can be performed by any appropriate device or system, e.g., any appropriate data processing apparatus. Operations of the process 300A can also be implemented as instructions stored on a computer readable medium which can be non-transitory. Execution of the instructions causes one or more data processing apparatus to perform operations of the process 300A.

At 302, an acoustic field is generated in a subterranean formation, by activating a signal source (e.g., signal source 106, described with reference to FIGS. 1A-1M). The signal source can be a wave source generating a wave that propagates through a subterranean formation. The acoustic source operates within the frequency range 1 Hz-150 kHz or at least has a portion of the acoustic signal within the frequency range of 1 Hz-150 kHz. The frequency range of 0.5-10 kHz is preferred as the most favorable for the excitation of a boundary wave or interface wave (e.g., Stoneley wave). The natural phenomena includes flow in the fracture, flow in the subterranean formation, drill bit operation, microseismicity. The source(s) can be either lowered on the wireline or slickline tools or deployed autonomously (as described with reference to FIGS. 1A-1M). In addition, they can be placed in the same or another well. The acoustic field can be generated by at least one acoustic source placed into the same or a neighbor wellbore (independent of a wellbore shape being vertical, slanted, horizontal, etc.). The source can be lowered into the wellbore on a cable, can be lowered into the wellbore autonomously (sensor ball). The source can be a drill bit. The source can include an array of sources.

At 304, an electromagnetic signal created by an electrokinetic effect occurring within the subterranean formation, detected by an optical fiber and propagated through the optical fiber is received, by one or more processors. The optical fiber, used as the primary detector, has unlimited aperture. At least one of the fields (acoustic and/or electromagnetic) is measured by the optical fiber as the main measurement system. In some implementations, the source and the detector(s) are placed in different wellbores (cross-well imaging).

At 306, additional data is received from a coupled detector, by the one or more processors. The additional data includes pressure data and acoustic data. The wavefield can be recorded by one or more sensors included in the detector (e.g., detector 112, described with reference to FIGS. 1A-1M). The spatial resolution of the receiver is greater than the wavelength of the signal to be detected. The signal source and the receiver can be decoupled and synchronized to a clock for simultaneous acquisition of the acoustic signal and acquiring the electromagnetic signal created by an electrokinetic effect. The electrokinetic measurement relies on using information on wave propagation in time. The synchronization can include hardware synchronization, provided the source is connected by the cable, synchronization by timing known events (e.g., first arrival of the signal on the fiber opposite the firing of the source), synchronization by using additional point hydrophone receivers deployed into the wellbore, and synchronization by using additional electromagnetic receivers deployed into the wellbore. of the pressure field P(t) and electromagnetic field (azimuth component of magnetic intensity Hθ(t) and axial component of electric intensity Ez(t)) in wellbore and/or on land/sea floor.

In some implementations, data collection can include setting up a frequency and/or a schedule of collecting data from the sensors of the coupled detector, as described with reference to FIGS. 1A-1M. Each of the sensors of the detector can be configured to activate data collection and/or transmission according to a respective schedule defining a frequency of data collection and a duration of each collection duration. The sensors can be configured to collect data continuously (according to the respective schedule) or can have a set trigger that initiates data collection in response to detection of one or more conditions for data collection. The conditions can be defined based on safety regulations and industrial plant operational conditions regarding an operational status (e.g., fully operational, partly operational, or minimally operational) one or more components of the industrial plant (e.g., example system 200 described with reference to FIG. 2). The additional data can be collected by sensors included in operating wells and observation wells within a field. The additional data can include surface data collected by probes located on or near a wellhead and subterranean data located within or near a downhole, the probe data being indicative of a health of a subterranean formation reservoir within the field. For example, the additional data can include field injection and re-production rate, injected and re-produced volume, well performance parameters, pressure measurements at different locations, temperatures at multiple locations, seismic (microseismic) data, bottomhole pressure, fluid composition, flow rate, reproduction rate, and any other measurable variable parameter indicative of a well operation and/or efficiency.

At 308, the electromagnetic data and the additional data is processed to determine formation characteristics, by the one or more processors. The data can be preprocessed to filter the data, to remove background noise, for example, by adaptive noise cancellation algorithms. Data filtering can include applying filters based on well characteristics and/or machine operational patterns to the probe data to generate filtered data. The data can be preprocessed to separate components of the acoustic response signals and electromagnetic signals. The data processing includes determining a position of the optical fiber using a cross correlation analysis between the signals detected by the hydrophones and the optical fiber. The cross-correlation analysis indicates the time delays and phase shifts between the signals, which are indicative of the relative positions of the sensors. The time delays and phase shifts obtained from the cross-correlation analysis can be used to calculate the position of the optical fiber relative to the hydrophones by solving the equations that relate the time delays to the distances between the sensors. The calculated positions can be validated by comparing the positions with known reference points or additional measurements to ensure accuracy. The separated components can be processed to perform time alignment of the acoustic data and electromagnetic data. The data processing includes estimating formation permeability from the characteristics of the boundary wave or interface wave (e.g., Stoneley wave) and associated electromagnetic signal in the subterranean formation (or vice versa). The data processing includes determining a coupling factor between the electric and acoustic fields, the factor between magnetic and acoustic fields and using the relationships for the coupling factors to determine the properties of interest.

For example, simultaneously acquired electromagnetic data and the additional data can be processed to determine fluid permeability (or mobility, denoted as m=κ₀/η, where κ₀ is the subterranean formation permeability, and η is the viscosity of pore fluid) in an earth formation through joint measurements of acoustic and electromagnetic waves. The measured pressure field P(t) and electromagnetic field (azimuth component of magnetic intensity Hθ(t) and axial component of electric intensity Ez(t)) in wellbore and/or on land/sea floor are separated into components of the acoustic response signals and electromagnetic signals for representing tube (Stoneley) wave. The separation of the wavefield components can be done using such techniques as Random transform, f-k filtering, etc. The Fourier transform is applied to the temporal representation of the pressure P(ω), the magnetic field intensity Hθ(ω), and the electric intensity Ez(ω). The frequency dependence of the ratio RH(ω) of complex-valued amplitude of Hθ(ω) to complex-valued amplitude of P(ω) is determined. The frequency dependence of the ratio RE(ω) of complex-valued amplitude of Ez(ω) to complex-valued amplitude of P(ω) is determined. The ratio of real and imaginary parts HP=Re(RH(ω))/Im(RH(ω)) and the ratio EP=Re(RE(ω))/Im(RE(ω)) representing the measured curves are determined. The formation and flow properties of interest are estimated.

For example, the permeability (or mobility) is estimated by solving an optimization problem to match analytic/modeled curves HP and EP with the measured ones. A forward modeling, for example, using finite-difference method, can be applied to determine the formation characteristics. The forward model simulates the physical processes within the subterranean formation to predict the response, which can be compared with actual measurements. The outcome of the forward model can be refined to increase the accuracy of the formation characteristics by using a prediction model (e.g., prediction model 221 described with reference to FIG. 2) or by applying optimization methods (e.g. Newton optimization, conjugate gradient).

Determining formation characteristics can include an analysis of the well health and reservoir integrity, including identification of well and reservoir vulnerabilities. Data correlation can include analyzing the aggregated data to determine a safety score indicative of the well health and reservoir integrity. In some implementations, the data correlation includes correlating, using prediction models (including trainable machine learning models, as described with reference to FIG. 2), subterranean microseismic data to well and reservoir characteristics connected to determine the integrity of the reservoir. The correlation can identify a connection between a safety risk and a system component or a group of system components that can be simultaneously exposed to an operational risk. The identified connection or correlation of vulnerability to a well operation, facilitates complementation of an action plan to address the identified risk. The correlation of the aggregated data can be performed using a machine learning model configured to identify a connection between a safety risk, a well operation, and a reservoir integrity. The machine learning model can include a machine learning model pre-trained and fine-tuned to identify the connection between the safety risk, the well operation, and the reservoir integrity by interpreting patterns of the aggregated data within the context of different risk types as defined by risk scenarios obtained from a database.

At 310, a mapping of the subterranean formation characteristics is generated, by the one or more processors. The generation of the mapping of the subterranean formation characteristics can include an extraction of a parameter of interest), which is related to the properties of interest (fluid mobility, etc.) to generate a three-dimensional data volume, indicating a variation of one or more subterranean formation characteristics within a spatial volume and/or over a time interval of interest (e.g., an identified time period during which a variation exceeding a set threshold occurred).

At 312, an action plan is generated, by the one or more processors of the server system, using the mapping of the subterranean formation characteristics. The action plan is generated to correct the determined well and/or reservoir vulnerabilities. The safety compliance score of the determined well and/or reservoir vulnerabilities can be compared to a reference score of the respective vulnerability type. The reference scores can be obtained from a database that stores the reference scores associated with a particular well or set of wells within a region of interest of a field. The reference scores represent a sustainability, integrity, and safety of the subterranean formation surface and subterranean system components. The difference between measured scores and reference scores can be quantified to identify the gaps indicative of compliance targets. The safety gap can be classified as minor, average or critical. The safety gap can be corrected using recommended remediation actions to increase the level of integrity and safety of well and reservoir operations to reach a target safety level. The action plan can be identified by machine learning models (e.g., recurrent neural networks with a multi-layer network topology) trained and fine-tuned to generate a set of remedial actions to correct safety gaps. The system can determine scores for each system component to be validated based on a difference between each predicted value and the target safety level for the respective component, and the accuracy for the machine learning model that generated the predicted value. The trained machine learning models can be configured to operate in active mode, within the server system, facilitating automatic action plan implementation. For example, the trained machine learning models can trigger a modification of system component operations for adjusting pressure, temperature, and/or volume, for example by valve and/or pump control. In some implementations, more than one trained machine model can be placed in active mode concurrently (that is, overlapping in a time), for example, for evaluating well operation safety considering different evaluation methods (e.g., one analyzing pressure, another analyzing temperature, another analyzing injected volume relative to a detected parameter, such as seismic data magnitude). The action plan is transmitted to be displayed by a graphical user interface. The action plan includes an automatic selection of remedial actions that can be triggered to be automatically performed based on the mapping of the characteristics of the subterranean formation. Remedial actions include, among other things, notification to an end user of an identified risk, compensation through well operation adjustment to mitigate the detected risk, and communication of the sensed vulnerability and risk to a field operator or well manager to fortify the safety and integrity of the well and of the reservoir. In some implementations, transmission for display of action plans and the remedial actions can be adjusted relative to a traffic light system that categorizes safety events (e.g., microseismic events) relative to determined potential consequences associated with the action plan. For example, automatic alerts can be sent by email and text messages for minor and medium level safety risk incidents associated to consequences indicative of well operation inefficiency and automatic performance of one or more operations can be implemented for critical events associated to potentially critical consequences suggesting a current or future well inoperability or potentially leading to critical events leading to destruction of well and reservoir. The alerts can be displayed as a notification summarizing the detected risk, such as a notification indicating that subterranean formation status is approaching a limit of an operational range for a particular location within the mapping of the characteristics of the subterranean formation.

At 314, in response to receiving a user input including a selection of a remediation operation or in response to determining that the remediation action plan addresses one or more critical events, the remediation operation is executed. The remediation operation can include a modification of a component of the system (adjustment of at least one device configuration setting), such as partly or completely closing one or more valves to regulate flow through the well, or activating a fan to regulate temperature, or activating or modifying parameters of a pump to control a flow rate. In response to executing the operation, an updated safety score can be determined and compared to the reference safety score. The comparison can indicate a success level of the remediation action plan and consequences can be used for further training of the machine learning models. If the updated safety score is greater than or equal to the reference safety score, a safety assessment report is provided for display, to the graphical user interface. The safety assessment report can be provided as a full or as a partially customized assessment. For example, the graphical user interface provides customizable features used for configuring the assessment reporting results and recommendations to monitor the health of the subterranean formation reservoir and well operation safety.

FIG. 3B depicts a flowchart illustrating an example process 300B for subterranean formation real time monitoring, in accordance with some example implementations. Referring to FIGS. 1A and 1B, the process 300B can be performed by any components of the example system 100. The example process 300B can be executed using, e.g., any component of the example system 100A-100M described with reference to FIGS. 1A-1M or example system 200, 400, 500 described with reference to FIGS. 2. 4, and 5. Operations of the process 300B are described below for illustration purposes only. Operations of the process 300B can be performed by any appropriate device or system, e.g., any appropriate data processing apparatus. Operations of the process 300B can also be implemented as instructions stored on a computer readable medium which can be non-transitory. Execution of the instructions causes one or more data processing apparatus to perform operations of the process 300B.

At 322, an electromagnetic field is generated in a subterranean formation, by activating a signal source (e.g., signal source 106, described with reference to FIGS. 1A-1M). The signal source can be a wave source generating a wave that propagates through a subterranean formation. The electromagnetic source operates within the frequency range 1 Hz-150 kHz or at least has a portion of the electromagnetic signal within the frequency range of 1 Hz-150 kHz. The frequency range of 0.5-10 kHz is preferred as the most favorable for the excitation of the Stoneley mode. The natural phenomena includes flow in the fracture, flow in the subterranean formation, drill bit operation, microseismicity. The source(s) can be either lowered on the wireline or slickline tools or deployed autonomously (as described with reference to FIGS. 1A-1M). In addition, they can be placed in the same or another well.

At 324, an acoustic signal created by an electrokinetic effect occurring within the subterranean formation in response to the generated electromagnetic field. The acoustic signal is detected by an optical fiber and propagated through the optical fiber for being received, by one or more processors. The optical fiber, used as the primary detector, has unlimited aperture. At least one of the fields (acoustic and/or electromagnetic) is measured by the optical fiber as the main measurement system.

At 326, additional data is received from a coupled detector, by the one or more processors, as described with reference to FIG. 3A.

At 328, data is processed to determine formation characteristics, by the one or more processors. The data processing includes estimating formation permeability from the characteristics of a boundary wave or interface wave (e.g., Stoneley wave) defining the propagation of the electromagnetic and acoustic field along a solid-solid interface characterizing the subterranean formation, as described with reference to FIG. 3A.

At 330, a mapping of the subterranean formation characteristics is generated, by the one or more processors, as described with reference to FIG. 3A. The generation of the mapping of the subterranean formation characteristics can include an extraction of a parameter of interest), which is related to the properties of interest (fluid mobility, etc.) to generate a three-dimensional data volume, indicating a variation of one or more subterranean formation characteristics within a spatial volume and/or over a time interval of interest (e.g., an identified time period during which a variation exceeding a set threshold occurred).

At 332, an action plan is generated, by the one or more processors of the server system, using the mapping of the subterranean formation characteristics, as described with reference to FIG. 3A.

At 334, an operation is triggered, by the one or more processors, to be executed by a machine, as described with reference to FIG. 3A.

The example processes 300A, 300B can further include simultaneous acquisition of the pressure field and electromagnetic field in wellbore and/or on land/sea floor. The example processes 300A, 300B can include preprocessing of the measured data to separate components of the acoustic response signals and electromagnetic signals. The example processes 300A, 300B can include continuous estimation of the subterranean formation and flow properties of interest. For example, estimation of the permeability (or mobility) or monitoring the position of a liquid front by solving the optimization problem to match analytic/modeled curves with the measured ones.

The example processes 300A, 300B incorporate real-time processing of synchronized acoustic and electromagnetic data. The example processes 300A, 300B generate accurate and consistent spatial and temporal characterization of subterranean formations. The example processes 300A, 300B can be used to monitor real-time data of crucial well operation parameters, such as gas flowrates, pressures, temperatures, and other parameters of subterranean formations including wells and reservoir. The data generated during the example processes 300A, 300B can be displayed on a user-friendly interface including various dashboards and reports, enabling a comprehensive performance analysis at field and well levels. The data generated during the example processes 300A, 300B can automatically trigger field operations for maintaining well safety.

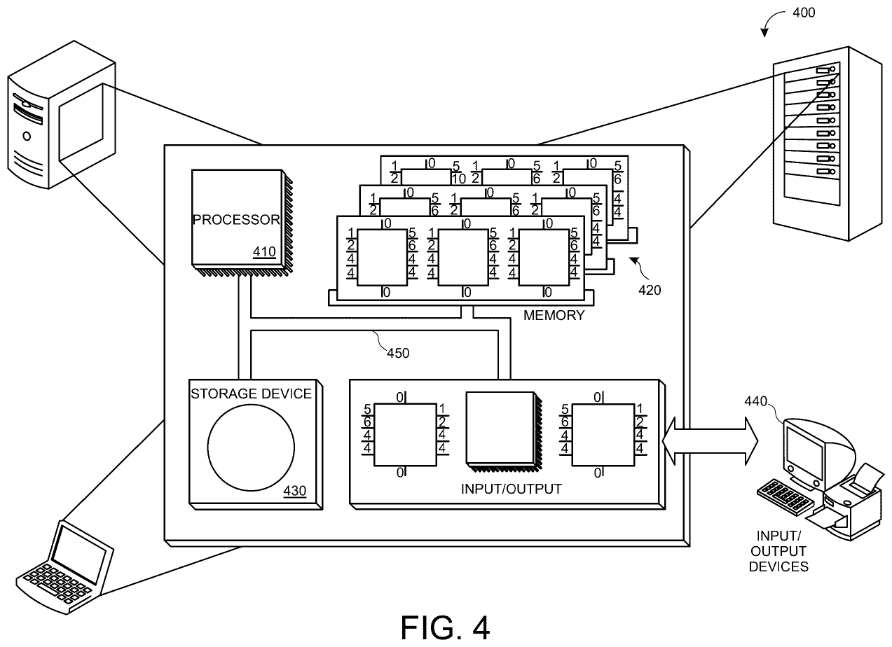

FIG. 4 depicts a block diagram illustrating a computing system 400, in accordance with some example implementations. Referring to FIGS. 1A-1M, the computing system 400 can be used to implement the server system 100A-100M and/or any other components of the example system 100.

As shown in FIG. 4, the computing system 400 can include a processor 410, a memory 420, a storage device 430, and input/output devices 440. The processor 410, the memory 420, the storage device 430, and the input/output devices 440 can be interconnected using a system bus 450. The processor 410 is capable of processing instructions for execution within the computing system 400. Such executed instructions can implement one or more components of, for example, the example system 100. In some implementations of the current subject matter, the processor 410 can be a single-threaded processor. Alternately, the processor 410 can be a multi-threaded processor. The processor 410 is capable of processing instructions stored in the memory 420 and/or on the storage device 430 to display graphical information for a user interface provided using the input/output device 440.

The memory 420 is a computer readable medium such as volatile or non-volatile that stores information within the computing system 400. The memory 420 can store data structures representing configuration object databases, for example. The storage device 430 is capable of providing persistent storage for the computing system 400. The storage device 430 can be a floppy disk device, a hard disk device, an optical disk device, or a tape device, or other suitable persistent storage means. The input/output device 440 provides input/output operations for the computing system 400. In some implementations of the current subject matter, the input/output device 440 includes a keyboard and/or pointing device. In various implementations, the input/output device 440 includes a display unit for displaying graphical user interfaces.

According to some implementations of the current subject matter, the input/output device 440 can provide input/output operations for a network device. For example, the input/output device 440 can include Ethernet ports or other networking ports to communicate with one or more wired and/or wireless networks (e.g., a local area network (LAN), a wide area network (WAN), the Internet).

In some implementations of the current subject matter, the computing system 400 can be used to execute various interactive computer software applications that can be used for organization, analysis and/or storage of data in various (e.g., tabular) format (e.g., Microsoft Excel®, and/or any other type of software). Alternatively, the computing system 400 can be used to execute any type of software applications. These applications can be used to perform various functionalities, e.g., planning functionalities (e.g., generating, managing, editing of spreadsheet documents, word processing documents, and/or any other objects), computing functionalities, or communications functionalities. The applications can include various add-in functionalities or can be standalone computing products and/or functionalities. Upon activation within the applications, the functionalities can be used to generate the user interface provided using the input/output device 440. The user interface can be generated and presented to a user by the computing system 400 (e.g., on a computer screen monitor).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random-access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

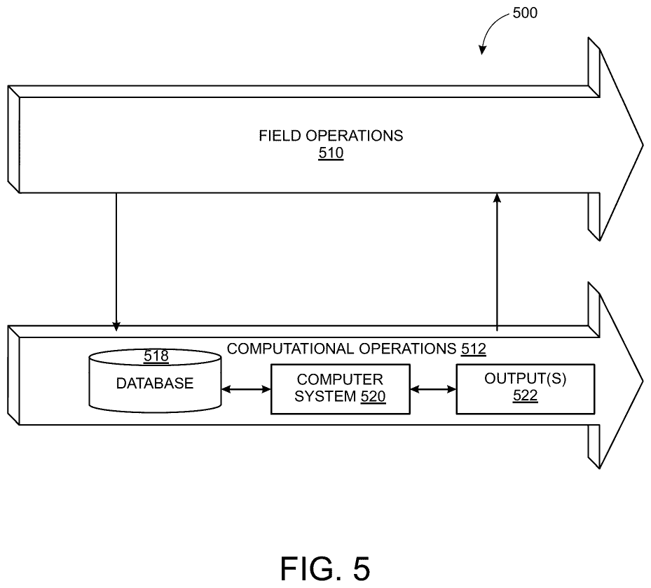

FIG. 5 illustrates hydrocarbon production operations 500 that include both one or more field operations 510 and one or more computational operations 512, which exchange information and control exploration for the production of hydrocarbons. In some implementations, outputs of techniques of the present disclosure can be performed before, during, or in combination with the hydrocarbon production operations 500, specifically, for example, either as field operations 510 or computational operations 512, or both.

Examples of field operations 510 include forming/drilling a wellbore, hydraulic fracturing, producing through the wellbore, injecting fluids (such as water) through the wellbore, to name a few. In some implementations, methods of the present disclosure can trigger or control the field operations 510. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 510 and responsively triggering the field operations 510 including, for example, generating plans and signals that provide feedback to and control physical components of the field operations 510. Alternatively, or in addition, the field operations 510 can trigger the methods of the present disclosure. For example, implementing physical components (including, for example, hardware, such as sensors) deployed in the field operations 510 can generate plans and signals that can be provided as input or feedback (or both) to the methods of the present disclosure.

Examples of computational operations 512 include one or more computer systems 520 that include one or more processors and computer-readable media (e.g., non-transitory computer-readable media) operatively coupled to the one or more processors to execute computer operations to perform the methods of the present disclosure. The computational operations 512 can be implemented using one or more databases 518, which store data received from the field operations 510 and/or generated internally within the computational operations 512 (e.g., by implementing the methods of the present disclosure) or both. For example, the one or more computer systems 520 process inputs from the field operations 510 to assess conditions in the physical world, the outputs of which are stored in the databases 518. For example, seismic sensors of the field operations 510 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 512 where they are stored in the databases 518 and analyzed by the one or more computer systems 520.

In some implementations, one or more outputs 522 generated by the one or more computer systems 520 can be provided as feedback/input to the field operations 510 (either as direct input or stored in the databases 518). The field operations 510 can use the feedback/input to control physical components used to perform the field operations 510 in the real world.

For example, the computational operations 512 can process the seismic data to generate three-dimensional (3D) maps of the subsurface formation. The computational operations 512 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 512 to process new information about the subterranean formation and control the drilling to adjust to the observed conditions in real-time.

The one or more computer systems 520 can update the 3D maps of the subsurface formation as information from one exploration well is received and the computational operations 512 can adjust the location of the next exploration well based on the updated 3D maps. Similarly, the data received from production operations can be used by the computational operations 512 to control components of the production operations. For example, production well and pipeline data can be analyzed to predict slugging in pipelines leading to a refinery and the computational operations 512 can control machine operated valves upstream of the refinery to reduce the likelihood of plant disruptions that run the risk of taking the plant offline.

In some implementations of the computational operations 512, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

The preceding figures and accompanying description illustrate example processes and computer implementable techniques. The environments and systems described above (or their software or other components) can contemplate using, implementing, or executing any suitable technique for performing these and other tasks. It will be understood that these processes are for illustration purposes only and that the described or similar techniques can be performed at any appropriate time, including concurrently, individually, in parallel, and/or in combination. In addition, many of the operations in these processes can take place simultaneously, concurrently, in parallel, and/or in different orders than as shown. Moreover, processes can have additional operations, fewer operations, and/or different operations, so long as the methods remain appropriate.

In other words, although the disclosure has been described in terms of certain implementations and generally associated methods, alterations and permutations of these implementations, and methods will be apparent to those skilled in the art. Accordingly, the above description of example implementations does not define or constrain the disclosure. Other changes, substitutions, and alterations are also possible without departing from the spirit and scope of the disclosure.

A number of implementations of the present disclosure have been described. Nevertheless, it will be understood that various modifications can be made without departing from the spirit and scope of the present disclosure. Accordingly, other implementations are within the scope of the following claims.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application.

Example 1. A method of characterizing a subterranean formation, the method comprising: generating, by activating a wave source, a wave propagating in a subterranean formation; receiving, from an optical fiber, data transmitted through the optical fiber in response to an electrokinetic effect generated in the subterranean formation in response to the wave propagating through the subterranean formation; receiving, from a sensor, additional data synchronized with the data transmitted through the optical fiber; determining, by processing the data transmitted through the optical fiber and the additional data, characteristics of the subterranean formation, the processing comprising a temporal alignment of the data transmitted through the optical fiber and the additional data; generating a mapping of the characteristics of the subterranean formation, the mapping defining a variation of the characteristics throughout the subterranean formation; and triggering a field operation within the subterranean formation based on the mapping of the characteristics of the subterranean formation.

Example 2. The method of the previous example, wherein the wave comprises an acoustic wave or an electromagnetic field.

Example 3. The method of any of the previous examples, wherein the optical fiber is within or proximal to a wellbore formed within the subterranean formation.

Example 4. The method of any of the previous examples, wherein the wave source is within or proximal to the wellbore formed within the subterranean formation.

Example 5. The method of any of the previous examples, wherein the optical fiber covers a plurality of azimuths.

Example 6. The method of any of the previous examples, wherein the optical fiber comprises localized sensors comprising any of Bragg gratings, optic hydrophones, coiled sections, electromagnetic sensitive coated sensors, and piezo elements.

Example 7. The method of any of the previous examples, wherein determining, by processing the data transmitted through the optical fiber, characteristics of the subterranean formation comprises: removing background noise using adaptive noise cancellation algorithms; preprocessing the data to separate acoustic data from electromagnetic data; determining coupling factors between the acoustic data and the electromagnetic data; and determining the characteristics of the subterranean formation based on the coupling factors.

Example 8. The method of any of the previous examples, wherein the field operation comprises fluid injection, hydraulic fracturing, or well drilling.

Example 9. A system of characterizing a subterranean formation, the system comprising: memory storing application programming interface (API) information; and a server performing operations comprising: generating, by activating a wave source, a wave propagating in a subterranean formation; receiving, from an optical fiber, data transmitted through the optical fiber in response to an electrokinetic effect generated in the subterranean formation in response to the wave propagating through the subterranean formation; receiving, from a sensor, additional data synchronized with the data transmitted through the optical fiber; determining, by processing the data transmitted through the optical fiber and the additional data, characteristics of the subterranean formation, the processing comprising a temporal alignment of the data transmitted through the optical fiber and the additional data; generating a mapping of the characteristics of the subterranean formation, the mapping defining a variation of the characteristics throughout the subterranean formation; and triggering a field operation within the subterranean formation based on the mapping of the characteristics of the subterranean formation.

Example 10. The system of the previous example, wherein the wave comprises an acoustic wave or an electromagnetic field.

Example 11. The system of any of the previous examples, wherein the optical fiber is within or proximal to a wellbore formed within the subterranean formation.

Example 12. The system of any of the previous examples, wherein the wave source is within or proximal to the wellbore formed within the subterranean formation.

Example 13. The system of any of the previous examples, wherein the optical fiber covers a plurality of azimuths.

Example 14. The system of any of the previous examples, wherein the optical fiber comprises localized sensors comprising any of Bragg gratings, optic hydrophones, coiled sections, electromagnetic sensitive coated sensors, and piezo elements.

Example 15. The system of any of the previous examples, wherein determining, by processing the data transmitted through the optical fiber, characteristics of the subterranean formation comprises: removing background noise using adaptive noise cancellation algorithms; preprocessing the data to separate acoustic data from electromagnetic data; determining coupling factors between the acoustic data and the electromagnetic data; and determining the characteristics of the subterranean formation based on the coupling factors.

Example 16. The system of any of the previous examples, wherein the field operation comprises fluid injection, hydraulic fracturing, or well drilling.

Example 17. A non-transitory computer-readable media encoded with a computer program, the computer program comprising instructions that when executed by one or more computers cause the one or more computers to perform operations comprising: generating, by activating a wave source, a wave propagating in a subterranean formation; receiving, from an optical fiber, data transmitted through the optical fiber in response to an electrokinetic effect generated in the subterranean formation in response to the wave propagating through the subterranean formation; receiving, from a sensor, additional data synchronized with the data transmitted through the optical fiber; determining, by processing the data transmitted through the optical fiber and the additional data, characteristics of the subterranean formation, the processing comprising a temporal alignment of the data transmitted through the optical fiber and the additional data; generating a mapping of the characteristics of the subterranean formation, the mapping defining a variation of the characteristics throughout the subterranean formation; and triggering a field operation within the subterranean formation based on the mapping of the characteristics of the subterranean formation.

Example 18. The non-transitory computer-readable media of the previous example, wherein the wave comprises an acoustic wave or an electromagnetic field.

Example 19. The non-transitory computer-readable media of any of the previous examples, wherein the optical fiber is within or proximal to a wellbore formed within the subterranean formation, wherein the wave source is within or proximal to the wellbore formed within the subterranean formation, wherein the optical fiber covers a plurality of azimuths.

Example 20. The non-transitory computer-readable media of any of the previous examples, wherein the optical fiber comprises localized sensors comprising any of Bragg gratings, optic hydrophones, coiled sections, electromagnetic sensitive coated sensors, and piezo elements.

What is claimed is:

1. A method of characterizing a subterranean formation, the method comprising:
generating, by activating a wave source, a wave propagating in a subterranean formation;
receiving, from an optical fiber, data transmitted through the optical fiber in response to an electrokinetic effect generated in the subterranean formation in response to the wave propagating through the subterranean formation;
receiving, from a sensor, additional data synchronized with the data transmitted through the optical fiber;
determining, by processing the data transmitted through the optical fiber and the additional data, characteristics of the subterranean formation, the processing comprising a temporal alignment of the data transmitted through the optical fiber and the additional data;
generating a mapping of the characteristics of the subterranean formation, the mapping defining a variation of the characteristics throughout the subterranean formation; and
triggering a field operation within the subterranean formation based on the mapping of the characteristics of the subterranean formation.

2. The method of claim 1, wherein the wave comprises an acoustic wave or an electromagnetic field.

3. The method of claim 1, wherein the optical fiber is within or proximal to a wellbore formed within the subterranean formation.

4. The method of claim 3, wherein the wave source is within or proximal to the wellbore formed within the subterranean formation.

5. The method of claim 3, wherein the optical fiber covers a plurality of azimuths.

6. The method of claim 1, wherein the optical fiber comprises localized sensors comprising any of Bragg gratings, optic hydrophones, coiled sections, electromagnetic sensitive coated sensors, and piezo elements.

7. The method of claim 1, wherein determining, by processing the data transmitted through the optical fiber, characteristics of the subterranean formation comprises:
removing background noise using adaptive noise cancellation algorithms;
preprocessing the data to separate acoustic data from electromagnetic data;
determining coupling factors between the acoustic data and the electromagnetic data; and
determining the characteristics of the subterranean formation based on the coupling factors.

8. The method of claim 1, wherein the field operation comprises fluid injection, hydraulic fracturing, or well drilling.

9. A system of characterizing a subterranean formation, the system comprising:
memory storing application programming interface (API) information; and
a server performing operations comprising:
generating, by activating a wave source, a wave propagating in a subterranean formation;
receiving, from an optical fiber, data transmitted through the optical fiber in response to an electrokinetic effect generated in the subterranean formation in response to the wave propagating through the subterranean formation;
receiving, from a sensor, additional data synchronized with the data transmitted through the optical fiber;
determining, by processing the data transmitted through the optical fiber and the additional data, characteristics of the subterranean formation, the processing comprising a temporal alignment of the data transmitted through the optical fiber and the additional data;
generating a mapping of the characteristics of the subterranean formation, the mapping defining a variation of the characteristics throughout the subterranean formation; and
triggering a field operation within the subterranean formation based on the mapping of the characteristics of the subterranean formation.

10. The system of claim 9, wherein the wave comprises an acoustic wave or an electromagnetic field.

11. The system of claim 9, wherein the optical fiber is within or proximal to a wellbore formed within the subterranean formation.

12. The system of claim 11, wherein the wave source is within or proximal to the wellbore formed within the subterranean formation.

13. The system of claim 11, wherein the optical fiber covers a plurality of azimuths.

14. The system of claim 9, wherein the optical fiber comprises localized sensors comprising any of Bragg gratings, optic hydrophones, coiled sections, electromagnetic sensitive coated sensors, and piezo elements.

15. The system of claim 9, wherein determining, by processing the data transmitted through the optical fiber, characteristics of the subterranean formation comprises:
removing background noise using adaptive noise cancellation algorithms;
preprocessing the data to separate acoustic data from electromagnetic data;
determining coupling factors between the acoustic data and the electromagnetic data; and
determining the characteristics of the subterranean formation based on the coupling factors.

16. The system of claim 9, wherein the field operation comprises fluid injection, hydraulic fracturing, or well drilling.

17. A non-transitory computer-readable media encoded with a computer program, the computer program comprising instructions that when executed by one or more computers cause the one or more computers to perform operations comprising:
generating, by activating a wave source, a wave propagating in a subterranean formation;
receiving, from an optical fiber, data transmitted through the optical fiber in response to an electrokinetic effect generated in the subterranean formation in response to the wave propagating through the subterranean formation;
receiving, from a sensor, additional data synchronized with the data transmitted through the optical fiber;
determining, by processing the data transmitted through the optical fiber and the additional data, characteristics of the subterranean formation, the processing comprising a temporal alignment of the data transmitted through the optical fiber and the additional data;
generating a mapping of the characteristics of the subterranean formation, the mapping defining a variation of the characteristics throughout the subterranean formation; and
triggering a field operation within the subterranean formation based on the mapping of the characteristics of the subterranean formation.

18. The non-transitory computer-readable media of claim 17, wherein the wave comprises an acoustic wave or an electromagnetic field.

19. The non-transitory computer-readable media of claim 17, wherein the optical fiber is within or proximal to a wellbore formed within the subterranean formation, wherein the wave source is within or proximal to the wellbore formed within the subterranean formation, wherein the optical fiber covers a plurality of azimuths.

20. The non-transitory computer-readable media of claim 17, wherein the optical fiber comprises localized sensors comprising any of Bragg gratings, optic hydrophones, coiled sections, electromagnetic sensitive coated sensors, and piezo elements.
